(19) United States
(12) Patent Application Publication
(10) Pub. No.: US 2012/0138040 A1
(43) Pub. Date: Jun. 7, 2012

(54) CUTTING BELT WITH DRIVE LUGS

(75) Inventors: Ken Barnes, Bedford, IN (US); Larry Lee, Oolitic, IN (US)

(73) Assignee: ALSA, LLC, Bedford, IN (US)

(21) Appl. No.: 12/960,007

(22) Filed: Dec. 3, 2010

(51) Int. Cl. B28D 1/08; B24D 18/00

(52) U.S. Cl. 125/21; 51/309

(57) ABSTRACT

Belt for cutting solid aggregate material such as natural or synthetic stone, include a main belt body comprised of a flexible material and having outer and inner loop surfaces. Multiple drive lugs project from the inner loop surface toward the interior of the loop, and each lug has a belt drive surface generally transverse to the main belt body. Multiple abrasive segments containing diamond particles are partially embedded in the main belt body, so that they form a part of the outer surface of the main belt body. Methods of manufacturing and using the cutting belt are also disclosed.

The present invention relates to cutting devices in general, and, in particular, to devices having a continuous flexible belt for cutting stones, including those in the ground, and methods for making and using such cutting devices.

Replaceable composite tools, such as those containing a polycrystalline diamond component or diamond particles allowing for mechanical removal of a hard material, are known to be useful for cutting stones in quarries, drilling rocks in mining or oil fields, extracting coal or other natural materials, and machining metals.

Stone cutting devices often contain a compacted composite abrasive as a cutting surface. The compacted composite abrasives generally contain a mass of abrasive particles, typically diamond or cubic boron nitride, bonded into a hard conglomerate. Manufactured under elevated temperature and pressure conditions, these abrasives are used in a variety of cutting, drilling, milling, and other operations. Diamond points on a segment of the compacted abrasive perform the desired grinding work.

Various means have been developed over the years for cutting stones and other hard materials once they have been removed from the ground. For example, U.S. Pat. No. 5,749,775 to Fish describes a diamond belt for cutting stones extracted from the ground. The belt includes continuous cables extending along the length of the belt and through bores in the drive blocks, a main body made from a resilient material, and rigid segments. The rigid segments and cables are embedded in the main body through an injection molding process, with the rigid segments having diamond surfaces that project slightly above the body of the belt.

Other means have been developed for cutting and removing hard natural stone from quarries. U.S. Pat. No. 5,305,730 to Fish describes a stone cutting belt including a flexible and continuous main body. The belt has a plurality of cutting segments. Each of the cutting segments has a drive block and carrier block mounted on top of the drive block. The carrier block includes a tooth slot in which a cutting tooth is mounted, such as by silver soldering for polycrystalline diamond tools. Continuous cables extend along the entire length of the belt and through bores in the drive blocks. The main body is made from a resilient material in which the cutter segments and cables are embedded via an injection molding process.

Abrasive elements are sometimes utilized in tools for grinding optical components, such as those composed of plastic or glass. For example, U.S. Pat. No. 5,891,206 to Ellingson describes metal-bonded abrasive tools having an annular rim of metal-bonded superabrasive joined to a central core, which is made from a metal that differs from that of the rim. The tools are constructed made in a single sintering step that yields a near net shape abrasive tool.

Wire-based cutting tools are likewise known. U.S. Pat. No. 6,283,112 to Beglund describes a continuous saw member having a wire and a plurality of cutting members which are connected and supported on the wire. Once mounted, the cutting members are connected to a rider for engaging a saw. The cutting elements are floatingly supported on the wire and in functional engagement with the driver members. In addition, U.S. Pat. No. 6,021,773 to Svensson discloses a wire saw having a plurality of cutting elements spaced apart along a continuous wire.

A method of making an abrasive wire for sawing stone is taught by U.S. Pat. No. 4,097,246 to Olson. The improvement resides in the step of affixing a solid abrasive body to a support element by deforming the axially-protruding free end of the underlying smaller-diameter portion of the support element so that it enlarges and assumes the same diameter as the other end of the support element, thereby sandwiching and locking the abrasive body solidly therebetween.

Tools for the precision grinding of ceramics and ceramic composites may employ abrasive elements. For example, U.S. Pat. No. 6,102,789 to Ramanath, et al., describes such a tool consisting of a wheel core attached to an abrasive rim of metal-bonded abrasive segments. The abrasive segments and core are bonded to one another by means of a thermally-stable bond.

U.S. Pat. No. 3,672,881 to Sowko describes a method for making powder composites. A powdered metal is initially pressed into contact with another pre-formed, previously sintered metal component and shaped. The hard metal component and the diamond segment are then hot pressed together, producing little change in the size of the finished product.

U.S. Pat. No. 6,112,739 to Hoerner, et al., discloses a high-speed cutting belt having periodic reliefs on the interior polymeric circumference of the belt. The reliefs are shallow, narrow cut-outs which work to remove particulate material, rather than drive the belt.

Means for driving a cutting belt may be external to the belt or at least components separate from the belt. U.S. Patent Application Publication No. 2010/0071681 A1, listing Bade as inventor, discloses embodiments of a stone cutting apparatus and methods for making same, including at least one sheave that is coupled to a stone cutting belt to drivingly engage the stone cutting belt. European Patent Publication No. 0358112, citing Madrigali as inventor, discloses a cutting belt with inner spaces between cutting elements, with the elements engaging cogs on a drive wheel and each being separately defined and bolted to the cutting belt.

Improvements to drive belt mechanisms have been made in other arts. U.S. Pat. No. 4,758,107 to Sakai discloses a belt drive mechanism in a web feed tractor for printers, with the tractor having means for preventing timing belt meandering. Namely, the timing belt is positively driven with pins on an outer surface of the belt engaging marginal perforations in a web being fed by the web feed tractor. U.S. Pat. No. 5,630,500 to Conrad teaches a positive-geared tracking pulley and belt for a reversible conveyor belt system, with at least one surface of the belt having a plurality of asymmetrical rows and columns of projections forming a matrix engageable with an offset mating tracking surface glued to a pulley.

Also known in the art is the use of a continuous channel in which a cutting belt travels. For example, European Patent Appl. No. 0527344, naming Weisner as inventor, teaches a jib for machines for cutting hard stone material utilizing a guide channel and web to engage a diamond-plate cutting belt.

To this day, civil engineering projects requiring stone quarrying and/or the cutting of concrete retain their importance. However, prior art devices for cutting stone do not satisfactorily address the slippage of a cutting belt on a drive wheel, a continuing problem which impacts the efficiency, and therefore the economic bottom line, of any operation attempting to cut solid material on a commercial basis. Cutting belts themselves can be expensive, and their slipping and subsequent jamming can damagingly melt plastic on the belt and drive mechanism. Belt slippage also certainly has safety ramifications, an important consideration whether the user is an employee or a private individual working on his or her own. A stable and durable belt useful for cutting stones, which may still be in the ground, at a higher rate of speed than in the prior art and with improved power transmission is therefore desirable.

### SUMMARY OF THE DISCLOSURE

The present invention includes embodiments of a belt for cutting solid aggregate material, including both hard and soft stone, as well as methods for manufacturing and using the belt. On its interior surface when looped, the belt includes lugs projecting toward the belt's interior and having a belt-driving surface generally transverse to the main body of the belt. Partially embedded in the belt's main body is a plurality of abrasive segments, thereby forming an outer surface.

More particularly, the cutting belt is made of a flexible material and comprises a main belt body having a width and outer and inner loop surfaces, with a plurality of drive lugs projecting from the inner loop surface toward the interior of the loop. Each drive lug comprises a surface for belt driving which is substantially transverse to the width of the main belt body. The widths of the drive lugs may, but need not be, less than the width of the drive belt. The plurality of abrasive segments partially embedded in the main belt body may comprise diamond particles and project beyond the main belt body. One or more cables may be substantially embedded in the main belt body to provide belt integrity and resiliency while allowing the belt to bend around a wheel, such as a drive wheel or a guide wheel. One or more bores may be cut in each abrasive segment for housing the cables. The flexible material may coat the cables and extends into and between the abrasive segments. The belt may include periodic grooves between its abrasive segments, reducing tension and increasing flexibility.

An illustrative system utilizing this cutting belt comprises at least one sheave in driven engagement with a stone cutting belt. The sheave has an outer circumference which includes a plurality of drive recesses capable of receiving the belt's drive lugs in order to drive the cutting belt upon rotation of the sheave. The outer circumference of the sheave may be comprised of an elastomeric material. An existing sheave may be retrofitted to accommodate the present invention through the use of a liner. This lug-and-recess drive mechanism yields improved cutting performance, in that it requires less amperes to obtain a certain cutting rate and permits an increase in amperes to be applied without belt slippage or damage, resulting in an increased cutting rate.

An illustrative method for manufacturing the cutting belt comprises the blending of a metal powder and diamond particles to form a homogenous mixture; cold pressing the mixture to form one or more abrasive segments; using a loop-shaped mold which defines surfaces for an outer loop and an inner loop; placing the abrasive segments into the mold such that a portion of each segment is flush with or extends above the mold's outer loop; and encapsulating a portion of the segments in a flexible material to create the cutting belt. The mold may define a plurality of drive lugs which project from the inner loop surface toward the interior of the loop, and each drive lug is defined by the mold as having a belt drive surface substantially transverse to the width of the belt. Additionally, in one embodiment, one or more looped cables are placed in the mold and encapsulated in the flexible material. The cutting belt may manufactured by molding and encapsulating the abrasive segments simultaneously or by manufacturing individual segments which are strung together on one or more cables.

An illustrative method for cutting stone using the cutting belt comprises providing a belt as described above and applying a force to the drive lugs to move the belt so the abrasive segments partially embedded in the belt's main body cut the stone.

### BRIEF DESCRIPTION OF THE DRAWINGS

FIG. 1 is a side view of a prior art jib comprising a portion of one embodiment of a cutting belt system;

FIG. 2 is a top perspective view of a cutting belt according to the present disclosure;

FIG. 3 is a bottom perspective view of the cutting belt of FIG. 2;

FIG. 4 is a top perspective view of another embodiment of a cutting belt according to the present disclosure;

FIG. 5 is a bottom perspective view of the cutting belt of FIG. 4;

FIG. 6 is a perspective view the cutting belt of FIGS. 2 and 3 partially engaging a sheave or drive wheel;

FIG. 7 is a perspective view of a sheave liner wheel which is to be used for engaging a cutting belt according to the present disclosure;

FIG. 8 is a fragmentary enlarged perspective view of the inner loop surface of the cutting belt of FIGS. 2 and 3;

FIG. 9 is a fragmentary enlarged perspective view of the inner loop surface of the cutting belt of FIGS. 2 and 3 with the drive lugs having an alternate geometry;

FIG. 10 is a fragmentary enlarged perspective view of the inner loop surface of the cutting belt of FIGS. 2 and 3 with the drive lugs having yet another alternate geometry; and

FIG. 11 is a fragmentary enlarged perspective view of the inner loop surface of a cutting belt with drive belt surfaces that are not “substantially transverse” to the width of a main belt body.

### DESCRIPTION OF THE ILLUSTRATIVE EMBODIMENTS

For the purposes of promoting an understanding of the principles of the disclosure, reference will now be made to the embodiments illustrated in the drawings and specific language will be used to describe the same. It will nevertheless be understood that no limitation of the scope of the claims is intended, with such alterations and further modifications to the illustrated device and such further applications of the principles of the disclosure as illustrated therein being contemplated as would normally occur to one skilled in the art.

This disclosure relates to abrasive cutting belts and methods for making and using them. Highly abrasive belts may be used for cutting stones such as limestone, slate marble, granite, and coral rock, as well as synthetic stones, asphalt, and concrete (whether precast or reinforced). As used in the claims, the terms stone or stones include any or all of the foregoing types of materials.

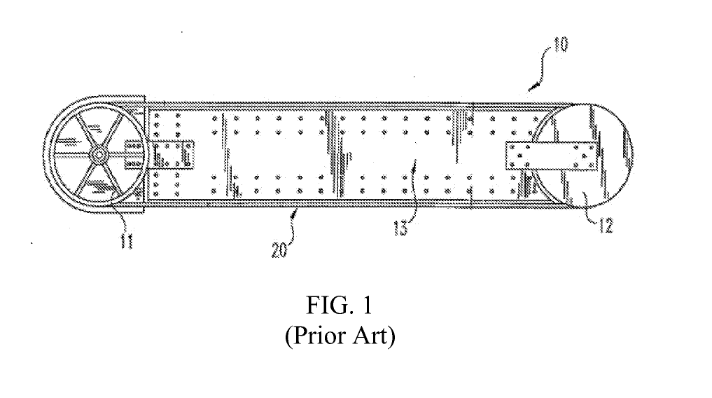

One application for the present invention, as a system, involves a jib device for cutting a slot in stone, as is described in U.S. Pat. No. 4,679,541 and U.S. Patent Application Publication No. 2010/0071681 A1. A jib 10, seen in FIG. 1, is pivotally mounted to the mainframe of a vehicle, with a pair of sheaves 11 and 12 mounted to the opposite ends of the jib 10. A jib frame 13 supports the sheaves 11 and 12 at opposite ends of the frame. Typically, sheave 11 will be situated above ground and driven by suitable means mounted in the vehicle. Incorporating the present invention, one or both of the sheaves 11 and 12 have an outer circumference 15 which includes a plurality of drive recesses 14. A cutting belt 20 extends in a continuous fashion around sheaves 11 and 12 and is immediately adjacent and engaged with the drive recesses 14 as discussed below.

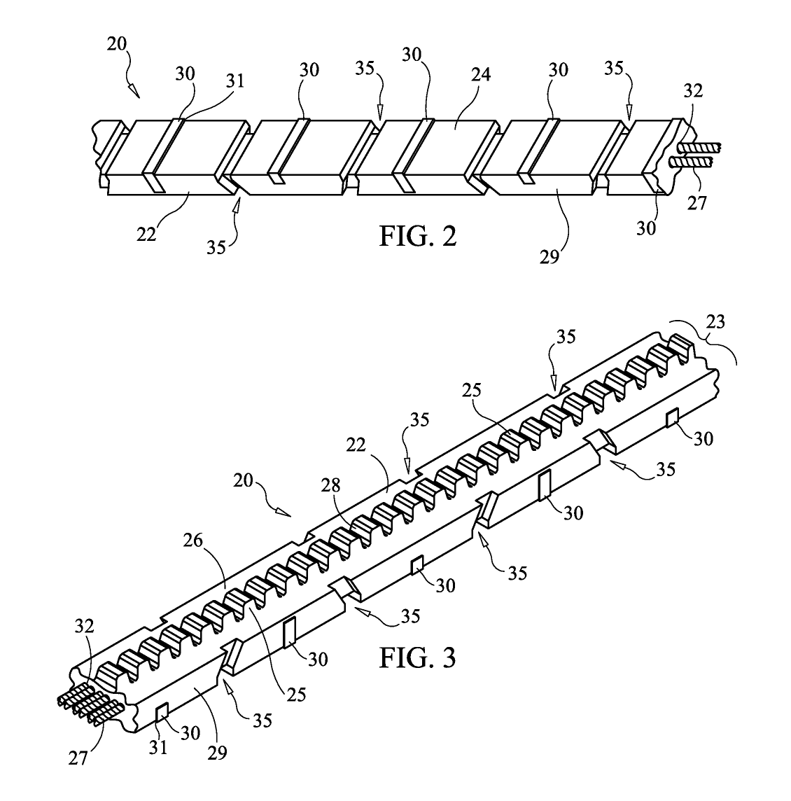

The cutting belt 20 is a continuous flexible belt which extends around the sheaves 11 and 12 and is in driven engagement with one or both of sheaves 11 and 12. As shown in FIGS. 2 and 2, the belt 20 includes a flexible main belt body 22 which is produced from polyurethane or another suitable plastic or flexible material. The main body 22 of belt 20 further comprises a width 23 and includes an outer loop surface 24 and an inner loop surface 26. A plurality of drive lugs 25 project from the inner loop surface 26 toward the interior of the looped belt 20. Each drive lug 25 has a belt drive surface 28 which is substantially transverse to the width 23 of the main belt body 22. The drive lugs 25 engage the sheave drive recesses 14, thereby enabling one or both of the sheaves to drivingly engage the belt upon rotation of the sheaves. The width of the drive lugs 25 is less than the width of the belt 20 in one illustrative embodiment of the present invention, but not in other embodiments. As discussed in more detail below, the shape of the drive lugs 25 and the drive recesses 14 may comprise various geometries, other than one comprising a continuous channel.

In one embodiment, substantially embedded in the main body 22 of the belt 20 are one or more cables 27 which extend through the length of the belt main body 22 to increase the strength thereof. As depicted in FIGS. 2 and 3, for example, the cables 27 are arranged in a row which extends at least partially across the width 23 of the belt main body 22. In one illustrative embodiment, the belt 20 includes a single cable 27 which extends multiple times around the length of the belt 20 thereby forming the multiple rows. Alternatively, a plurality of wire cables 27 may be arranged in side-by-side fashion with each cable 27 extending through the length of the belt 20. The cables 27 may be composed of a metallic high-tension wire, such as galvanized or stainless steel aircraft cable, but may also be made of a suitable plastic, nylon, or other material.

Each of the cables 27 is continuous throughout the length of the belt 20. In the alternative, the free ends of cables could be joined to other free ends of adjacent cables, thereby producing a single, continuous cable 27 formed from several cables. The cables 27 may have a uniform shape and cross-section, for example that of a circle. There may be instances where irregularities in the cables 27 are preferred, for example, an increased radius of cable may be desired for a certain portion of the cable. Also contemplated within this disclosure are cables that are non-continuous, provided the belt has necessary strength to function, and cables with a cross-section that is not circular or is irregularly shaped.

Partially embedded in the main body 22 of the belt 20 is a plurality of rigid abrasive segments 30. The abrasive segments 30 may each contain one or more bores 32, through which the cables 27 may be threaded, thereby connecting the segments 30 to main body 22. The abrasive segments 30 may be regularly spaced and connected both to each other and to the cable 27, by the flexible main body 22, which fills both the bores 32 of the abrasive segments 30 and intervals between the individual rigid segments 30. Flexible main body 22 may surround the cable 27, thereby insulating it from the bore walls and preventing wear on the cable that might otherwise occur as the belt flexes while traveling around the sheaves. The specific dimensions of the abrasive segments 30 in the main body 22 of the belt 20 may vary from those depicted in the drawings.

Optionally, the belt 20 will include periodic notches or grooves 35 to permit water to be effectively pumped into a cutting site and assist with the removal of slurry or other debris during cutting. Even with water pumped to the cutting site, there will be no hydroplaning of the cutting belt 20. In this illustrative embodiment, the grooves 35 may be cut into the outer loop surface 24 of the main body 22, the side 29 of the main body 22, or both. The need for, and dimension of, the grooves 35 will vary, depending on the application and the type of material being cut. The shape of the grooves 35 in one embodiment is a straight line, but it is envisioned that they may be X-shaped, chevron-shaped, or any number of other shapes, or a combination thereof.

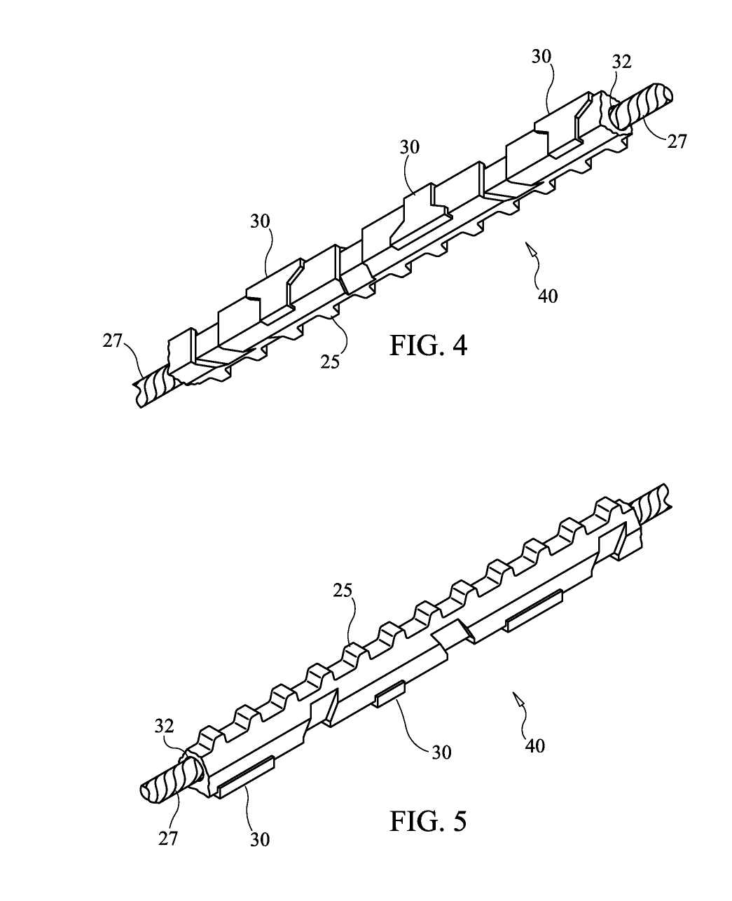

Often, at a large-scale quarrying site where in-ground stone is being cut, initial larger blocks of stone are cut with a larger-sized belt such as that shown in FIGS. 2 and 3. These initial blocks could be up to 150′ in length. A narrower belt 40, for example that illustrated in FIGS. 4 and 5, may be employed to slice the initial blocks into smaller pieces or slabs. The narrow belt 40 has a cross-section which is generally an inverted V-shape in one illustrative embodiment, with the larger surface area on top of the belt 40 used for contact with the stone or other substance being cut, and a single integrity cable 27 running through its interior.

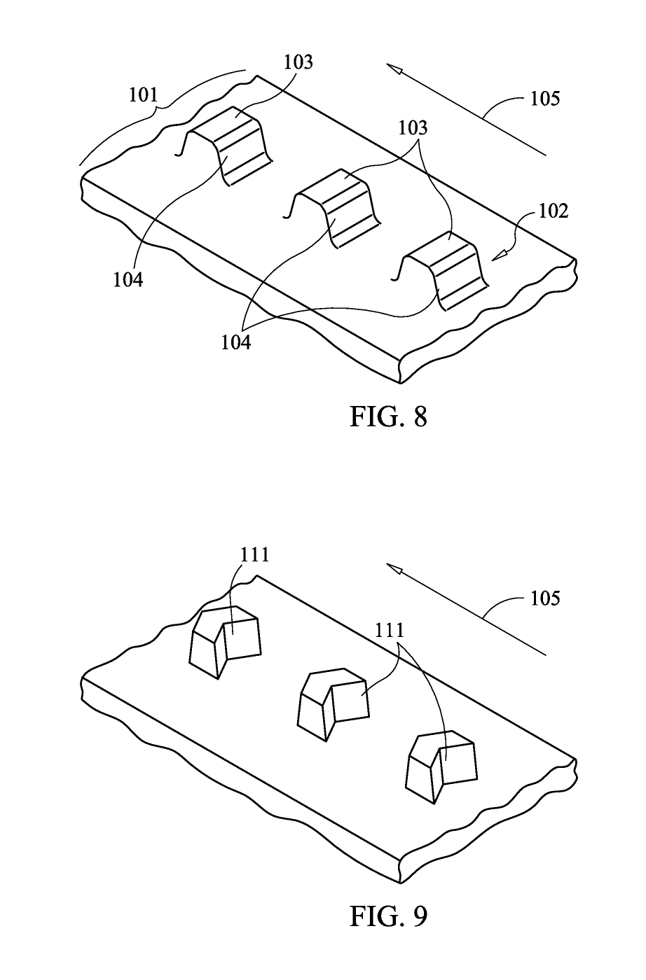

With respect to the precise geometry of the drive lugs 25, as shown in more detail in FIG. 8, the main belt body has a width 101 and is comprised of a flexible material, and has outer (not shown) and inner 102 loop surfaces. A plurality of drive lugs 103 project from the inner loop surface 102 toward the interior of the belt 20 loop. Each drive lug 103 has a belt drive surface 104 which is substantially transverse to the width 101 of main belt body 102. As used herein and in the claims, the belt drive surface 104 being “substantially transverse” means that its geometry is such that applying a force to the surface will tend to cause the cutting belt 20 to move in a continuously looping direction. This looping direction is shown by arrow 105.

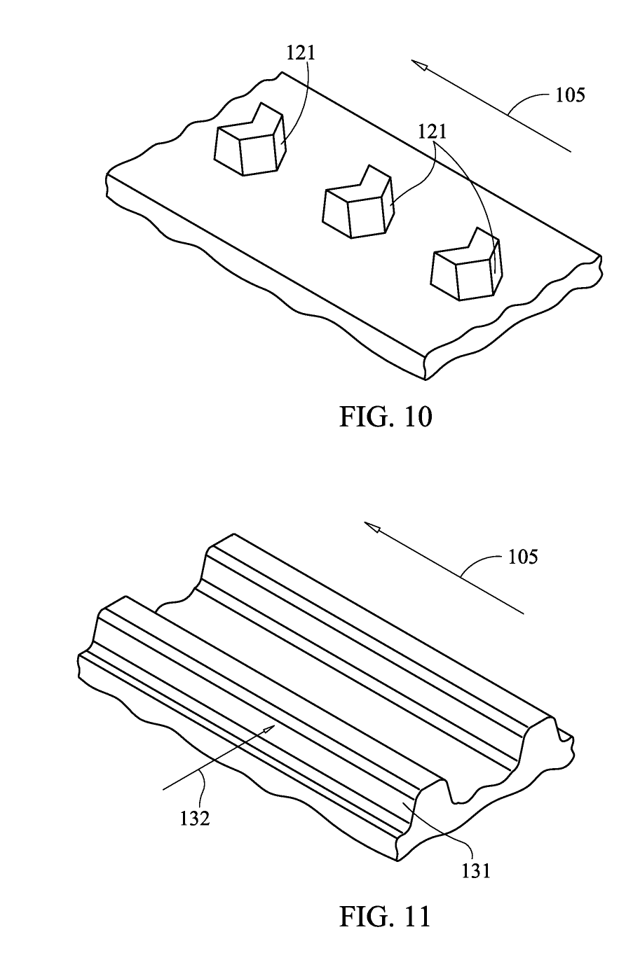

While the belt drive surface 104 shown in FIG. 8 has a planar surface, other surface geometries may be utilized. The selection of a given geometry, or the spacing between lugs, may be made for aesthetic reasons. For example, FIGS. 9 and 10 illustrate belt drive surfaces V-shaped 111 and inverted V-shaped 121 configurations, respectively, yet they are still “substantially transverse” to main belt body 102 because applying a force to them in the direction of desired movement 105 will tend to cause the cutting belt 20 to move in a continuously looping direction. In contrast, FIG. 11 shows a surface 131 that is not “substantially transverse” to the width of a belt, because applying force 132 to it would instead tend to push that belt sideways, or perpendicular to, the direction in which the belt should loop.

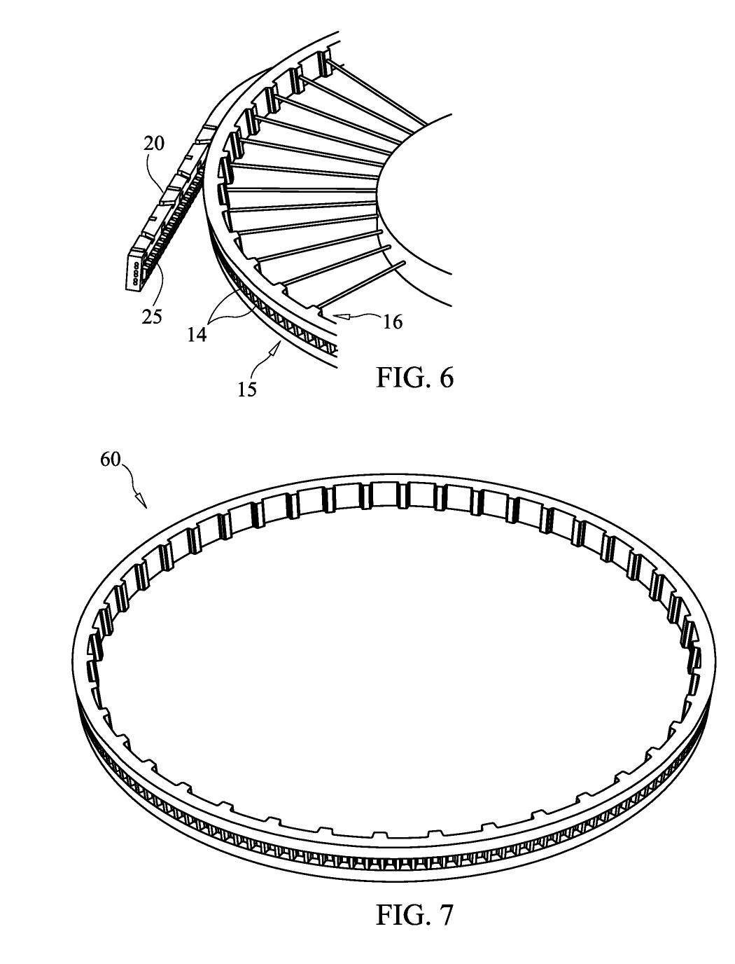

Implementing the disclosed cutting belt as a system will require the use of at least one sheave or drive wheel with drive recesses that can receive the drive lugs of a belt as illustrated in FIG. 6, with the lugs 25.

A sheave that does not have recesses to receive a belt with drive lugs may be retrofitted to use such a lugged belt. One way to provide such a retrofit is to use a liner 60, depicted in FIG. 7. The interior projecting lugs of the liner 60 can mate with the recesses in a drive wheel (not shown).

The cross-sectional width of the liner 60 may be less if a narrow cutting belt 40 is being used. The liner 60 may include cables on its interior for integrity purposes, similar to those in the cutting belt 20. The present invention could be used on any sort of belt-based saw, including handheld devices such as a retrofitted chain saw for cutting timber.

Turning to methods for manufacturing the cutting belt 20 disclosed herein, formation of the abrasive segments 30 will first be discussed. The abrasive segments 30 occur at regular intervals, along the main body 22. As seen in FIGS. 2 and 3, the outer surface 24 of main body 22 occupies the intervals between abrasive segments 30. In one illustrative embodiment, the interval between abrasive segments 30 is three inches. It is contemplated that there might be uses for which having a substantially smaller interval between abrasive segments 30 would be useful, although that could result in difficulty bending the belt 20 around the sheaves 11 and 12, and that there may be uses where a larger interval between abrasive segments 30 is needed. These variations are within the boundaries of this disclosure.

In one illustrative embodiment, as seen from the view of belt in FIG. 2, the abrasive segments 30 extend slightly beyond the side 29 and/or outer loop surface 24 of the main body 22. This overhang 31 of abrasive segments 30 may enable, and, more specifically, a staggered arrangement of overhanging abrasive segments 30, may help eliminate vibration of the belt 20 during a cutting operation and be used to equalize wear of the belt 20 components. In some embodiments, the overhang 31 may alternate sides between abrasive segments 30. It is also contemplated that abrasive segments 30 may have overhangs 31 which extend beyond only one side of the belt 20 and that the overhangs 31 may alternate belt 20 sides in a different manner, symmetrically or asymmetrically. In one embodiment, the abrasive segments 30 protrude 1/16″ from the surface of the belt main body 22. It is also contemplated that the abrasive segments 30 may be any of a variety of shapes, including, but not limited to, an L-shape or a C-shape, and that a single belt 20 may incorporate abrasive segments 30 of differing shapes. An illustrative embodiment of the narrow belt 40 incorporates abrasive segments 30 which are 0.530″ wide on a belt which is 0.406″ wide; these abrasive segments 30 are 0.188″ in height, with 0.092″ of the segments' height above the top, outer surface of the narrow belt 40 main belt body.

An abrasive segment 30 is made using methods known in the art, such as by mixing a large number of particles of small diamond, or an alternate hard cutting substance, with a metal powder, generally a softer metal, which serves as a filler. Suitable hard particles include carbons such as diamonds (i.e., natural synthetic and polycrystalline diamonds), nitrides (i.e., cubic boron nitride), carbides, and borides. At least some of the hard particles may be in the form of agglomerates of the individual hard particles. The metal power may be, for example, cobalt, copper, or tin.

The hard diamond particles are capable of performing an abrasive function and may be distributed throughout, either uniformly or non-uniformly, the abrasive segment 30. A tumbler which can mix along many axes will yield more homogeneous mixing results. Each abrasive segment 30 generally consists of hard particles present in an amount of 70 percent, and, more often, 80 to 90 percent, by volume, though there may be applications where lower volumes, such as 60, 50, or 40 percent may be useful. In a particular embodiment, bronze is used as the filler and diamonds (size of U.S. 16-20 mesh) are positioned uniformly throughout the abrasive segment 30.

This mixture of hard particles and filler is then cold pressed (for example, at approximately 80 to 200 kN) to an exact weight and approximate size. In one illustrative embodiment, following cold pressing, a bore 32 is formed in the abrasive segment 30 by placing the mixture in a mold, such as a carbon or graphite mold, which defines an aperture sized to accommodate one or more cables 27. The mold and mixture are then placed under high heat and high pressure and hot pressed, but not melted, to form abrasive segment 30. Hot pressing may be done at a temperature in the range of approximately 500° C. to 700° C. under a pressure in the range of 15 MPa to 48 MPa. As is known in the art, the temperature may be increased gradually prior to applying pressure to the mold contents. Following hot pressing, the mold is stripped from the abrasive segment 30, which is then cooled.

The abrasive segment 30 is finished to the desired dimensions and tolerances by conventional techniques, including blurring and sandblasting to a final form. It may be primed such that polyurethane, which is the material that will form the main body 22 of the belt 20, will adhere to it. Abrasive segments 30 may be “threaded” onto a cable 27, through the bore 32. If a single cable 27 is used, the cable may be repeatedly looped through the bore 32 in abrasive segment 30. Alternatively, multiple cables 27 may be used or, if the cable 27 has sufficient strength, it may only go through the bore 32 in abrasive segment 30 once. The cable 27 need not be pre-tensioned, but may be, for example at approximately 1,000 pounds. The cable 27 may also be coated with a primer, thus allowing the plastic of main body 22 to adhere to the cable 27.

In an illustrative embodiment, mounting the abrasive segment 30 to the cutting belt 20 is accomplished through the use of metallic mounting segments known in the art. In particular, to preserve diamond supply, a non-diamond mounting segment may be used between the abrasive segment 30 and the belt body 22. This mounting segment may be metallic or plastic. Exemplary mounting segments are composed of a cemented carbide such as cemented tungsten carbide, cemented tantalum carbide, cemented titanium carbide, or a mixture thereof. An abrasive segment 30 and a mounting segment are cold pressed separately and placed together in a mold and hot pressed to form the final abrasive segment 30 in this embodiment. In an alternate embodiment utilizing a mounting segment, the abrasive segments 30 may be made in a manner that does not involve melting of the base metals.

Proceeding to the manufacture of the final belt 20, an injection mold, aluminum in one embodiment, is used, and, essentially, a portion of the abrasive segments 30 and all of the interior cables 27 are encapsulated in a flexible material to create the belt 20. More particularly, the mold is loop-shaped and will define outer loop and inner loop surfaces. The mold further defines a plurality of drive lugs 25 which project from the inner loop surface toward the interior of the looped mold. Each drive lug 25 is defined by the mold as having a belt drive surface 104 that is substantially transverse to the width of the belt 20. The mold will preferably have a plurality of apertures through which any excess polyurethane may flow for ease of removal.

The cables 27 and abrasive segments 30 are placed in the mold and positioned such that a portion of each abrasive segment 30 is flush with the mold's outer loop surface. The mold temperature may be approximately 150° F. when the abrasive segments 30 and cables 27 are positioned in the mold. A liquid, thermal-setting polyurethane, or another material desired for the main belt body 22, is then injected into the mold, and fills it, to encapsulate the abrasive segments 30 and the cables 27. The flexible material coats the cables 27 and extends into and between the abrasive segments 30. During the injection molding process, the polyurethane may infiltrate bores 32 in the abrasive segments 30, surrounding the cables 27, and securely anchoring abrasive segment 30 to the cables 27. The belt 20 may then be cured at approximately 280° F. In this manner, the abrasive segments 30 and the cable 27 are embedded in main body 22.

After the elastomer is poured into the mold, any air in the plastic will tend to float upwards as bubbles to the top of the mold, from where this excess material may be removed from the cutting belt 20. As is known in the art, a computer may control the various cycles of this manufacturing process. It will be possible to manufacture an entire belt 20 at once, with no pre-tensioning at the time of manufacture. In the alternative, a belt 20 may be made one segment at a time and “threaded” onto a cable 27, with pre-tensioning occurring at the time of manufacture. Further, the belt 20 may be patched, assuming the interior cables 27 are not damaged. If the cables 27 are damaged, their repair may be accomplished by first burning off the polyurethane and then performing the necessary mending. A long life is envisioned for the belt components, so repair is believed to be worthwhile.

The material used for the main belt body 22 may be a flexible material, such as an elastomer yielding high-quality vulcanizates of 80 durometer A hardness when cured with a Mannich base curing agent and having good tear strength, good abrasion resistance, and excellent flex life. An exemplary elastomer will be very flexible at low temperatures, having a torsional modulus of 10,000 psi (703 kg/sq. cm) at −80° F. (−62° C.) and a brittleness temperature of −130° F. (−90° C.). Preferably, the elastomer will have properties within the following values:

| PROPERTY | VALUE |
|---|---|
| Brookfield Viscosity, poise @ 30° C. | 120-220 |
| Hardness, durometer A | 80 |
| 100% Modulus, psi (MPa) | 400 (28) |
| 300% Modulus, psi (MPa) | 625 (44) |
| Tensile Strength, psi (MPa) | 3000 (211) |
| Specific Gravity | 1.075 |
| Elongation at Break, % | 800 |
| % NCO Content | 2.65-2.95 |

The present system allows a belt 20 with lugs 25 to be retrofitted to an existing stone cutting system by inserting a liner 60, illustrated in FIG. 7, over the sheave 11 comprising a drive wheel. Possibly made in two or more sections to facilitate installation over the sheave 11, the liner 60 may be comprised of a flexible material, such as an elastomer which has excellent low-temperature flexibility, excellent abrasion resistance, good hydrolytic stability, and good compression set resistance. In particular, in one illustrative embodiment the liner 60 is composed of the same material as the cutting belt main body 22. Another embodiment employs a polyether-based liquid urethane prepolymer that is readily processable by conventional hand and machine mixing techniques and which produces high-quality elastomers in the 88-92 durometer A hardness range when cured with 4,4′-Methylene-bis[2Chloroaniline] or a urethane curative. In one embodiment, the elastomeric material used for the liner 60 will have properties within the following values:

| PROPERTY | VALUE |
|---|---|
| Brookfield Viscosity, poise @ 30° C. | 140-240 |
| Brookfield Viscosity, poise @ 100° C. | 4.0-6.0 |
| Hardness, durometer A | 90 |
| 100% Modulus, psi (MPa) | 1025 (7.0) |
| 300% Modulus, psi (MPa) | 2000 (13.8) |
| Tensile Strength, psi (MPa) | 4200 (29.0) |
| Elongation at Break, % | 410 |
| % Bashore Rebound | 45 |
| Specific Gravity @ 25° C. (77° F.) | 1.10 |
| Available Isocyanate Content, % | 3.95-4.34 |

As indicated, the cutting belt 20 disclosed herein may be utilized for cutting naturally-occurring solid aggregates of minerals or synthetic stone. An illustrative method of using the belt 20 for this application begins with positioning a cutting belt 20 manufactured according to the present disclosure in a continuous fashion around a pair of wheels, at least one of which is a sheave, mounted to a jib in one embodiment. The drive lugs 25 on the belt 20 are engaged with the drive recesses 14 on the outer circumference 15 of the sheave or on a liner 60 as discussed herein. A portion of the outer surface 24 of the belt 20 is then placed against the stone which is to be cut, and the belt 20 is moved such that the abrasive segments 30 partially embedded in the belt 20 cut the stone by friction. This will usually necessitate mechanical, high-speed belt motion, possibly by a driving mechanism connected to the jib. Sensors may be built into the system to detect whether the cutting belt 20 is caught and, if so, then cease the delivery of power to the driving mechanism.

While the invention has been illustrated and described in detail in the drawings and foregoing description, the same is to be considered as illustrative and not restrictive in character, it being understood that all changes and modifications that come within the spirit of the invention are desired to be protected.

What is claimed is:

1. A stone cutting belt comprising:
a looped main belt body having a width and comprised of a flexible material, and having outer and inner loop surfaces;
a plurality of drive lugs projecting from the inner loop surface toward the interior of the looped main belt body,
each drive lug having a belt drive surface substantially transverse to the width of the main belt body;
a plurality of abrasive segments partially embedded in the main belt body, wherein:
each abrasive segment forms a part of the outer surface of the main belt body.

2. The stone cutting belt of claim 1, wherein the main belt body and the plurality of drive lugs each have widths, and the widths of the drive lugs are less than the width of the drive belt.

3. The stone cutting belt of claim 1, further comprising one or more cables substantially embedded in the main belt body.

4. The stone cutting belt of claim 1, wherein the abrasive segments comprise diamond particles.

5. A stone cutting belt system comprising:
at least one sheave in driven engagement with a stone cutting belt, said stone cutting belt comprising:
a looped main belt body having a width and comprised of a flexible material, and having outer and inner loop surfaces;
a plurality of drive lugs projecting from the inner loop surface toward the interior of the looped main belt body,
each drive lug having a belt drive surface substantially transverse to the width of the main belt body;
a plurality of abrasive segments partially embedded in the main belt body, wherein:
each abrasive segment comprises diamond particles, and
each abrasive segment forms a part of the outer surface of the main belt body;
the sheave having an outer circumference, the outer circumference having a plurality of drive recesses capable of receiving the drive lugs to thereby drive the stone cutting belt upon rotation of the sheave.

6. The stone cutting belt system of claim 5 wherein the outer circumference of the sheave is comprised of an elastomeric material.

7. The stone cutting belt system of claim 5, further comprising one or more cables substantially embedded in the main belt body.

8. A method of manufacturing a stone cutting belt comprising the steps of:
blending a first metal powder and diamond particles together to form a mixture, and cold pressing said mixture to form a plurality of abrasive segments;
providing a mold for a looped belt,
the mold defining a belt outer loop surface a belt and an inner loop surface,
the mold defining a plurality of drive lugs projecting from the inner loop surface toward the interior of the looped belt,
each drive lug having a belt drive surface substantially transverse to the width of the belt;
placing the abrasive segments into the mold such that the a portion of each abrasive segment is flush with the outer loop surface of the mold; and
encapsulating the abrasive segments cable in a flexible material to create a stone cutting belt.

9. The method of claim 8, further comprising the steps of:
placing one or more looped cables in the mold; and
encapsulating the cable in the flexible material.

10. A method for cutting stone, comprising:
Providing a stone cutting belt comprising:
a looped main belt body having a width and comprised of a flexible material, and having outer and inner loop surfaces;
a plurality of drive lugs projecting from the inner loop surface toward the interior of the looped main belt body,
each drive lug having a belt drive surface substantially transverse to the width of the main belt body;
a plurality of abrasive segments partially embedded in the main belt body, wherein:
each abrasive segment comprises diamond particles, and
each abrasive segment forms a part of the outer surface of the main belt body;
placing a portion of the outer loop surface of the stone cutting belt against stone to be cut; and
applying force to the drive lugs to move the belt so that the abrasive segments cut the stone.

11. The method of claim 10, wherein the main belt body has one or more cables substantially embedded therein.
